(19) United States
(12) Patent Application Publication
(10) Pub. No.: US 2008/0069072 A1
(43) Pub. Date: Mar. 20, 2008

(54) FRAUDULENT SYNCHRONIZATION BURST DETECTION

(75) Inventors: Edgar Herbert Callaway, Boca Raton, FL (US); Paul E. Gorday, West Palm Beach, FL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/552,684

(22) Filed: Oct. 25, 2006

Related U.S. Application Data
(60) Provisional application No. 60/825,728, filed on Sep. 15, 2006.

(51) Int. Cl. H04B 7/216

(52) U.S. Cl. 370/342

(57) ABSTRACT

During operation of a secondary communication system (100), a random exponential back off for future sync bursts will be executed following the detection of an unauthenticated beacon. More particularly, a cognitive radio (104) acts on every sync burst received, until acting on one results in the reception of no beacon or an unauthenticated beacon. The cognitive radio then begins a random exponential back off procedure, in which it must receive a random number of sync bursts before it will schedule time to receive a beacon. For each unauthenticated beacon received, the back off exponent is incremented, thereby increasing the number of sync bursts that must be received before it will schedule time to receive a beacon again.

### FIELD OF THE INVENTION

The present invention relates generally to fraudulent synchronization burst detection and in particular, to a method and apparatus for performing a security back off when a fraudulent synchronization burst is detected.

### BACKGROUND OF THE INVENTION

In a cognitive radio system of the type considered for use by IEEE 802.22, a cognitive secondary radio system will utilize spectrum assigned to a primary system using an opportunistic approach. With this approach, the secondary radio system will share the spectrum with primary incumbents as well as those operating under authorization on a secondary basis. Under these conditions, it is imperative that any user in the cognitive radio system not interfere with primary users.

A proposed technique for identifying available channels for use by the secondary communication system involves measuring the use of a beacon to advertise the presence of the primary user of the spectrum. The beacon has sufficient time available to it that a full, 16-byte cryptographic message integrity code (MIC) can be appended to it, so that a received beacon can be authenticated by the cognitive radio (or other authorized device receiving the beacon).

A problem exists with using beacons because the data required to be sent in the beacon is typically greater than can be sent during an available window of reception. In order to solve this, a series of short “synchronization bursts” is proposed, with each synchronization burst identifying a time when the beacon is to be sent. A cognitive radio must then only receive one of these short bursts in order to know when the beacon will be sent. The cognitive radio then schedules a relatively long silent period for the beacon transmission time, during which it receives and decodes the beacon.

A problem with this approach is that the synchronization bursts, which are typically only 3 bytes in length, can have no cryptographic protection, and thus can be spoofed. A denial-of-service security hole therefore exists in which a user may send false synchronization bursts, leading the cognitive radio to monitor the channel for false beacons, or beacons that are never sent. The cognitive radio's throughput may thereby be reduced to an unacceptable degree. Therefore, a need exists for a method and apparatus for detecting and reducing fraudulent synchronization bursts.

### BRIEF DESCRIPTION OF THE DRAWINGS

FIG. 1 is a block diagram of a communication system.

FIG. 2 is a block diagram of a node of FIG. 1.

FIG. 3 is a flow chart showing operation of the node of FIG. 2 for a first embodiment of the present invention.

FIG. 4 is a flow chart showing operation of the node of FIG. 2 for a second embodiment of the present invention.

### DETAILED DESCRIPTION OF THE DRAWINGS

In order to address the above-mentioned need, a method and apparatus for detecting and reducing fraudulent synchronization bursts is provided herein. During operation of a secondary communication system, a random back off for future sync bursts will be executed following the detection of an unauthenticated beacon. More particularly, a cognitive radio acts on every sync burst received, until acting on one results in the reception of no beacon or an unauthenticated beacon. The cognitive radio then begins a random back off procedure, in which it must receive a random number of sync bursts before it will schedule time to receive a beacon. In a first embodiment of the present invention an exponential back off is utilized. For each unauthenticated beacon received, the back off is incremented, thereby increasing the number of sync bursts that must be received before it will schedule time to receive a beacon again.

While the malevolent sync burst transmitter will have initial success in interrupting the cognitive radio, his effect will quickly be reduced to a nuisance level by the effect of the exponential back off. Further, since the malevolent sync burst transmitter will be unable to predict how many sync bursts will be needed at any time to influence the cognitive radio (due to the random nature of the back off), he must transmit sync bursts continuously even to ensure that he will produce a nuisance.

The present invention encompasses a method for detecting and acting upon a fraudulent synchronization burst. The method comprises the steps of receiving a synchronization burst advertising a time period when a beacon may be received, determining that the synchronization burst was fraudulent, and initiating a procedure wherein a number of synchronization bursts must be received before scheduling a time to receive the beacon.

The present invention additionally encompasses a method comprising the steps of receiving a synchronization burst advertising a time period when a beacon may be received, determining that a counter (C) has expired, listening for the beacon only when the counter has expired, and determining if the synchronization burst was fraudulent. The counter is incremented when the synchronization burst was fraudulent, otherwise the counter is decremented.

The present invention additionally encompasses a method comprising the steps of listening for a synchronization burst advertising a time period when a beacon may be received, wherein the step of listening only takes place when a counter (C) has expired, receiving the synchronization burst advertising a time period when a beacon may be received, listening for the beacon, and determining if the synchronization burst was fraudulent. The counter is incremented when the synchronization burst was fraudulent, otherwise the counter is decremented.

The present invention encompasses an apparatus comprising a receiver receiving a synchronization burst advertising a time period when a beacon may be received and logic circuitry determining that the synchronization burst was fraudulent and initiating a procedure wherein a number of synchronization bursts must be received before scheduling a time to receive the beacon.

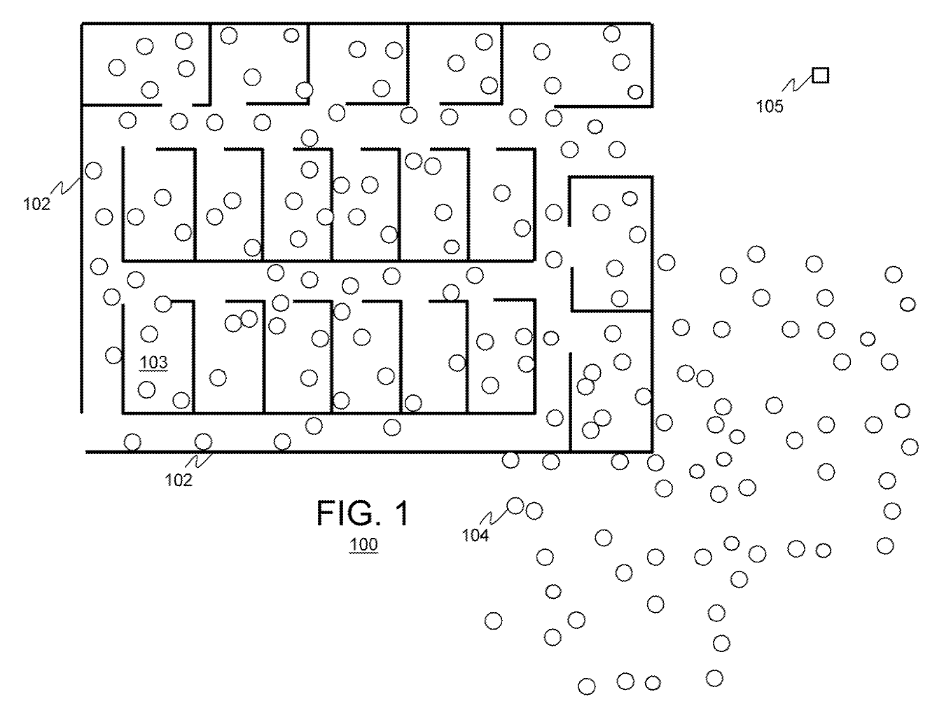

Turning now to the drawings, wherein like numerals designate like components, FIG. 1 is a block diagram of communication system 100 deployed inside and outside an interior of an office building. Communication system 100 is preferably a cognitive radio system that comprises a number of wireless devices 104 involved in determining the presence of a beacon to advertise the presence of the primary user of the spectrum. The office building comprises perimeter wall 102 that encloses a plurality of rooms 103 (only one labeled).

Circular objects, or nodes 104 (only one labeled) represent wireless devices that operate as part of a secondary communication system, and utilize spectrum assigned to a primary communication system using an opportunistic approach. With this approach, secondary nodes 104 will share the spectrum with primary nodes 105 as well as those operating under authorization on a secondary basis.

It should be noted that although FIG. 1 shows nodes 104 existing within a two-dimensional space, one of ordinary skill in the art will recognize that nodes 104 may be located in other environments, including 3-dimensional spaces. For example, nodes 104 may comprise public safety first responder radio equipment located within a multi-level building, golf carts equipped with wireless transceivers located on a golf course, inventory tags located within a multi-level warehouse, . . . , etc.

Rectangular object, 105 represents a wireless device that transmits a beacon. Particularly, object 105 will transmit a series of short “synchronization bursts” identifying a time when a beacon is to be sent, and preferably transmit a beacon at the appropriate time period. As discussed above, the synchronization bursts have no cryptographic protection, and thus can be spoofed. A denial-of-service security hole therefore exists in which a user may send false synchronization bursts, leading the cognitive radio to monitor the channel for false beacons, or beacons that are never sent.

In order to address this issue, cognitive radios 104 will receive a synchronization burst advertising a time period when a beacon may be received, and then make a determination if any synchronization burst was fraudulent. If a fraudulent synchronization burst is detected by any radio 104, the radio 104 will initiate a random back off procedure, in which it must receive a number of sync bursts before it will schedule time to receive a beacon. A synchronization burst is determined to be fraudulent when either no beacon is received at the appropriate time, or an unauthenticated beacon is received. Thus, after the beacon is received, the determination that the synchronization burst is fraudulent will be based on the failure to authenticate the beacon. In a similar manner, after failing to receive the beacon at the appropriate time, the determination that the synchronization burst is fraudulent is based on the failure to receive the beacon.

For each unauthenticated beacon received, the back off exponent is incremented, thereby increasing the number of sync bursts that must be received before it will schedule time to receive a beacon again.

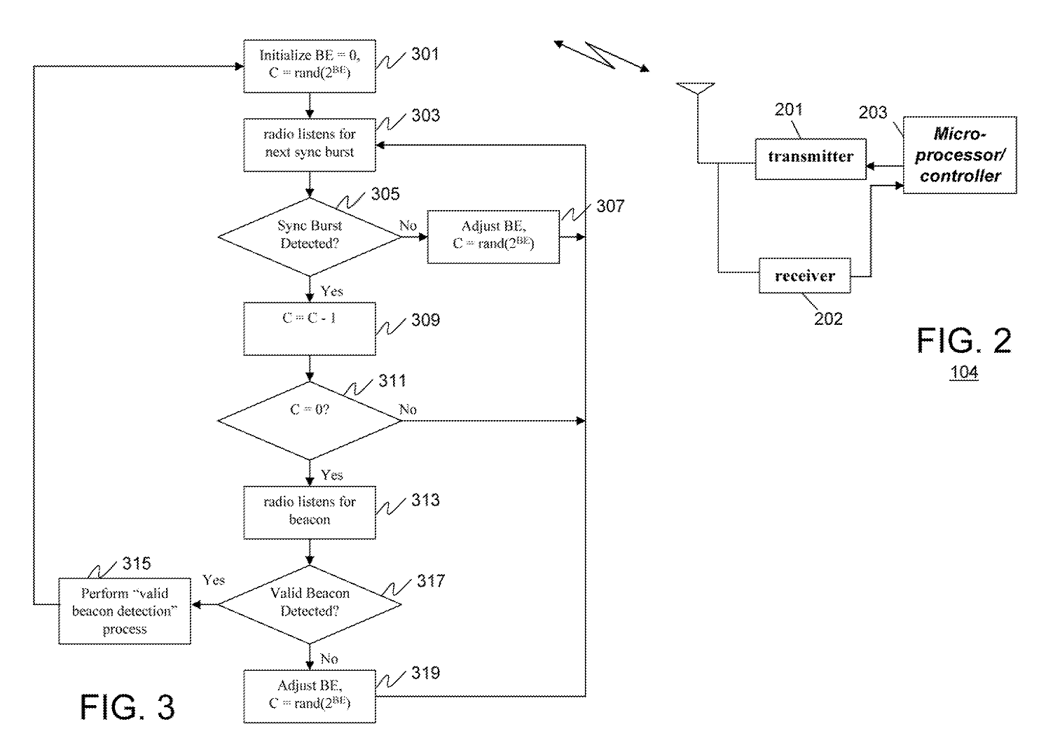

FIG. 2 is a block diagram of node 104. As shown, node 104 comprises logic circuitry 203 (microprocessor 203), receive circuitry 202, and transmit circuitry 201. Logic circuitry 203 preferably comprises a microprocessor controller, such as, but not limited to, a Freescale PowerPC microprocessor. In the preferred embodiment of the present invention logic circuitry 203 serves as means for controlling node 104. Receive and transmit circuitry are common circuitry known in the art for communication utilizing a well known communication protocol, and serve as means for transmitting and receiving messages. For example, receiver 202 and transmitter 201 are well known transmitters that utilize the IEEE 802.22 communication system protocol. Other possible transmitters and receivers include, but are not limited to transceivers utilizing Bluetooth, IEEE 802.11, or HyperLAN protocols.

FIG. 3 is a flow chart showing operation of the node of FIG. 2 for a first embodiment of the present invention. During the first embodiment of the present invention nodes 104 will listen for synchronization bursts, however, will only listen for a beacon when a counter (C) expires. A number (C) of synchronization bursts must be received before scheduling a time to receive the beacon.

The logic flow begins at step 301 where logic circuitry 203 initializes a variable (BE) to zero, where the counter C is a random integer between 0 and 2^{BE} (i.e., C=rand(2^{BE})). At step 303 receiver 202 listens for synchronization bursts and at step 305, logic circuitry 203 determines if a synchronization burst was detected. If, at step 305, it has been determined that a synchronization burst has been detected, the logic flow continues to step 309, otherwise the logic flow continues to step 307. At step 307 the value of BE is adjusted, following a policy, and a new value for counter C is determined. The policy at step 307 may decrement BE by 1(i.e., BE=BE−1) every time step 307 is reached, or it may be more sophisticated; e.g., it may require that the value of BE be decremented only after a predetermined number of synchronization bursts have been missed. The logic flow then returns to step 303.

At step 309 logic circuitry 203 decrements the counter by 1 and at step 311 logic circuitry 203 determines if counter C has expired (C=0). If C=0, logic circuitry 203 instructs receiver 202 to listen for the beacon (step 313); otherwise, the logic flow returns to step 303. At step 317 logic circuitry 203 determines if a valid beacon was received. As discussed, an invalid beacon will be assumed for either an un-received beacon, or a beacon that was not properly authenticated. Thus, at step 317 logic circuitry 203 will attempt to authenticate any received beacon.

If a valid beacon was received, logic circuitry 203 performs a valid beacon detection process (step 315). More particularly, logic circuitry 203 processes the information contained in the beacon, and takes action to avoid interference to the services protected by the beacon.

Continuing, if at step 317, logic circuitry 203 determines that a valid beacon was not received (and hence the synchronization burst was fraudulent); at step 319 logic circuitry 203 follows a predetermined policy. The policy at step 319 may increment BE by 1 (i.e., BE=BE+1) each time a valid synchronization burst was not received, and select a new random integer value for counter C between 0 and 2^{BE}. It may also be more sophisticated, and require a predetermined number of invalid beacons to be received before it increments BE, or have different policies for un-received beacons and beacons that were received but not properly authenticated. In yet a further embodiment of the present invention, every time an invalid synchronization burst is detected, logic circuitry 203 increases counter C, and thus increasing the number of synchronization bursts that must be received before scheduling a time to receive the beacon. The logic flow then returns to step 303.

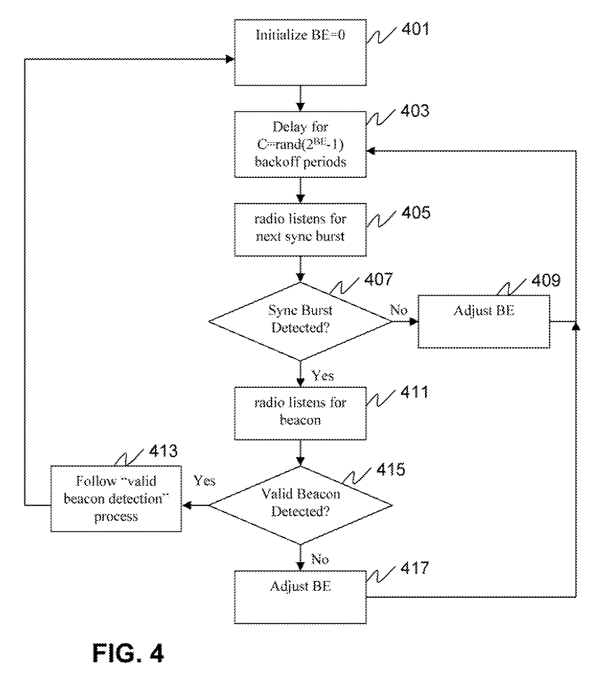

FIG. 4 is a flow chart showing operation of the node of FIG. 2 for a second embodiment of the present invention. During the second embodiment of the present invention, nodes will listen for synchronization bursts and beacons only after a counter (C) expires. The logic flow begins at step 401 where logic circuitry 203 initializes a variable (BE) to zero, where the counter C is a random integer between 0 and 2^{BE} minus 1 (i.e., C=rand(2^{BE})−1). At step 403 logic circuitry 203 instructs receiver 202 to delay listening for synchronization bursts or beacons for a period of time that is a function of C, for example a period C×Ts, where Ts is a protocol slot time. After the back off period, receiver 202 listens for the next synchronization burst (step 405) and logic circuitry 203 determines if a synchronization burst was detected (step 407). If no synchronization burst was detected, the logic flow continues to step 409 where the value of BE is adjusted, following a policy. The policy at step 409 may decrement BE by 1 every time step 409 is reached, or it may be more sophisticated; e.g., it may require that the value of BE be decremented only after a predetermined number of synchronization bursts have been missed. The logic flow returns to step 403.

If, at step 407, a synchronization burst is detected, then the logic flow continues to step 411 where receiver 202 listens for the beacon at the appropriate time period. A determination is made as to whether a valid beacon was detected (step 415). As discussed, an invalid beacon comprises either no beacon, or an un-authenticated beacon. If a valid beacon was detected logic circuitry 203 performs a valid beacon detection process (step 315). However, if a valid beacon was not detected, at step 417 logic circuitry 203 follows a predetermined policy. The policy at step 417 may increment BE by 1 (i.e., BE=BE+1) each time a valid beacon was not received. It may also be more sophisticated, and require a predetermined number of invalid beacons to be received before it increments BE, or have different policies for un-received beacons and beacons that were received but not properly authenticated. In yet a further embodiment of the present invention, every time an invalid synchronization burst is detected, logic circuitry 203 increases counter C, and thus increasing the time between attempts to detect the synchronization burst and beacon. The logic flow returns to step 403.

In one embodiment of the present invention, at steps 319 and 417 the value of BE is incremented only up to a maximum value maxBE. When BE=maxBE, BE is no longer incremented at steps 319 and 417. Without this maximum, a determined attacker could force BE to such large values that substantially no beacons would be received, effectively disabling the channel monitoring capability of cognitive radios 104. Note that in step 319 a new value of C is selected regardless of the value of BE.

While the invention has been particularly shown and described with reference to a particular embodiment, it will be understood by those skilled in the art that various changes in form and details may be made therein without departing from the spirit and scope of the invention. It is intended that such changes come within the scope of the following claims.

1. A method for detecting and acting upon a fraudulent synchronization burst, the method comprising the steps of:
receiving a synchronization burst advertising a time period when a beacon may be received;
determining that the synchronization burst was fraudulent; and
initiating a procedure wherein a number of synchronization bursts must be received before scheduling a time to receive the beacon.

2. The method of claim 1 wherein the step of determining that the synchronization burst was fraudulent comprises the steps of:
receiving the beacon;
failing to authenticate the beacon; and
determining that the synchronization burst was fraudulent based on the failure to authenticate the beacon.

3. The method of claim 1 wherein the step of determining that the synchronization burst was fraudulent comprises the steps of:
failing to receiving the beacon at an appropriate time; and
determining that the synchronization burst was fraudulent based on the failure to receive the beacon.

4. The method of claim 1 wherein the number of synchronization bursts that must be received before scheduling a time to receive the beacon comprises a random number of synchronization bursts that must be received before scheduling a time to receive the beacon.

5. The method of claim 1 wherein the beacon is used to advertise the presence of the primary user of the spectrum.

6. The method of claim 1 further comprising the steps of:
receiving a second synchronization burst advertising a time period when a second beacon may be received;
determining that the second synchronization burst was fraudulent; and
increasing the number of synchronization bursts that must be received before scheduling a time to receive the beacon.

7. The method of claim 6 wherein the step of determining that the second synchronization burst was fraudulent comprises the steps of:
receiving the second beacon;
failing to authenticate the second beacon; and
determining that the second synchronization burst was fraudulent based on the failure to authenticate the second beacon.

8. The method of claim 6 wherein the step of determining that the second synchronization burst was fraudulent comprises the steps of:
failing to receiving the second beacon at an appropriate time; and
determining that the second synchronization burst was fraudulent based on the failure to receive the second beacon.

9. A method comprising the steps of:
receiving a synchronization burst advertising a time period when a beacon may be received;
determining that a counter (C) has expired;
listening for the synchronization burst only when the counter has expired;
determining if the synchronization burst was fraudulent.

10. The method of claim 9 wherein C is a random integer between 0 and 2^{BE} where BE is a variable that is adjusted according to a policy.

11. The method of claim 10 wherein the step of incrementing the counter comprises the step of incrementing BE and the step of decrementing the counter comprises the step of decrementing BE.

12. The method of claim 9 wherein the step of determining that the synchronization burst was fraudulent comprises the steps of:
receiving the beacon;
failing to authenticate the beacon; and
determining that the synchronization burst was fraudulent based on the failure to authenticate the beacon.

13. The method of claim 9 wherein the step of determining that the synchronization burst was fraudulent comprises the steps of:
failing to receiving the beacon at an appropriate time; and
determining that the synchronization burst was fraudulent based on the failure to receive the beacon.

14. A method comprising the steps of:
listening for a synchronization burst advertising a time period when a beacon may be received, wherein the step of listening only takes place when a counter (C) has expired;
receiving the synchronization burst advertising a time period when a beacon may be received;
listening for the beacon;
determining if the synchronization burst was fraudulent.

15. The method of claim 14 wherein C is a random integer between 0 and 2^{BE} where BE is a variable that is adjusted according to a policy.

16. The method of claim 15 wherein the step of incrementing the counter comprises the step of incrementing BE and the step of decrementing the counter comprises the step of decrementing BE.

17. The method of claim 14 wherein the step of determining that the synchronization burst was fraudulent comprises the steps of:
receiving the beacon;
failing to authenticate the beacon; and
determining that the synchronization burst was fraudulent based on the failure to authenticate the beacon.

18. The method of claim 14 wherein the step of determining that the synchronization burst was fraudulent comprises the steps of:
failing to receiving the beacon at an appropriate time; and
determining that the synchronization burst was fraudulent based on the failure to receive the beacon.

19. An apparatus comprising:
a receiver receiving a synchronization burst advertising a time period when a beacon may be received; and
logic circuitry determining that the synchronization burst was fraudulent and initiating a procedure wherein a number of synchronization bursts must be received before scheduling a time to receive the beacon.

20. The apparatus of claim 19 wherein the determination that the synchronization burst was fraudulent is based on failing to authenticate the beacon.
